(19) United States
(12) Patent Application Publication
(10) Pub. No.: US 2016/0264432 A1
(43) Pub. Date: Sep. 15, 2016

(54) METHOD FOR REMOVING HEAVY METALS FROM WATER

(71) Applicant: SYNCRUDE CANADA LTD. in trust for the owners of the Syncrude Project as such owners exist now and, Fort McMurray (CA)

(72) Inventors: WARREN ZUBOT, Edmonton (CA); GAIL BUCHANAN, Fort McMurray (CA)

(21) Appl. No.: 14/645,736

(22) Filed: Mar. 12, 2015

(51) Int. Cl. C02F 1/28

(52) U.S. Cl. CPC C02F 1/283; C02F 2101/103

(57) ABSTRACT

A process for treating water containing heavy metals is provided comprising removing petroleum coke from a coking operation; forming a petroleum coke/water slurry by adding the water to be treated to the petroleum coke; and depositing the petroleum coke/water slurry into a containment cell and retaining the petroleum coke/water slurry in the cell for a retention time sufficient to remove a portion of the heavy metals.

### FIELD OF THE INVENTION

The present invention relates generally to the removal of heavy metals including selenium, arsenic, barium, nickel and strontium from water and, in particular, from industrial wastewater such as oil sands process water.

### BACKGROUND OF THE INVENTION

The invention relates to water treatment, in particular, the removal of heavy metals from industrial wastewater. Many heavy metals, if present at elevated concentrations in such water, can pose health problems for humans, animals and, in particular, aquatic life. Heavy metals such as selenium are often found in petroleum and a fraction of these heavy metals will appear in wastewater after petroleum processing.

In particular, for the past 25 years, the bitumen in Athabasca oil sand has been commercially recovered using a hot water-based extraction process. In the first step of this process, the oil sand is slurried with hot process water, naturally entrained air and, optionally, caustic (NaOH). The slurry is mixed, for example in a tumbler or pipeline, for a prescribed period of time, to initiate a preliminary separation or dispersal of the bitumen and solids and to induce air bubbles to contact and aerate the bitumen. This step is referred to as “conditioning”.

The conditioned slurry is then further diluted with flood water and introduced into a large, open-topped, conical-bottomed, cylindrical vessel (termed a primary separation vessel or “PSV”). The diluted slurry is retained in the PSV under quiescent conditions for a prescribed retention period. During this period, aerated bitumen droplets rise and form a bitumen froth layer, which continuously overflows the top lip of the vessel and is collected away in a launder. Heavier sand grains sink and are concentrated in the conical bottom together with the water. They leave the bottom of the vessel as a wet tailings stream containing a small amount of bitumen. Middlings, a watery mixture containing solids and bitumen, extend between the froth and sand layers.

The wet tailings and middlings are separately withdrawn, combined and sent to a secondary flotation process. This secondary flotation process is commonly carried out in a deep cone vessel wherein air is sparged into the vessel to assist with flotation. This vessel is referred to as the TOR vessel. The bitumen recovered by flotation in the TOR vessel is recycled to the PSV. The middlings from the deep cone vessel are further processed in induced air flotation cells to recover contained bitumen.

The froths produced by the PSV and flotation cells are then combined and subjected to further froth cleaning, i.e., removal of entrained water and solids, prior to upgrading. Typically, bitumen froth comprises about 60% bitumen, 30% solids and 10% water. There are currently two commercially proven processes to clean bitumen froth. One process involves dilution of the bitumen froth with a naphtha solvent, followed by bitumen separation in a sequence of scroll and disc centrifuges. Alternatively, the naphtha diluted bitumen may be subjected to gravity separation in a series of inclined plate separators (“IPS”) in conjunction with countercurrent solvent extraction using added naphtha, or some combination of both.

All of these steps in water extraction of bitumen from oil sands require a substantial amount of water, over 80 percent of which is recycled water from the tailings ponds (referred to herein as oil sands process water or OSPW). Currently, the industry stores all OSPW within tailings facilities and do not actively release the water to the environment. The ability to return appropriately treated/remediated OSPW to the environment is necessary to execute aquatic and terrestrial reclamations projects, optimize total tailings volumes, and ensure salt concentrations in OSPW do not become excessive because of water reuse practices.

Bitumen can also be extracted from oil sands in situ (in the geological formation) using the Steam Assisted Gravity Drainage process (the “SAGD” process). SAGD requires the generation of large amounts of steam in steam generators, which is injected via injection wells to fluidize the bitumen for recovery. A bitumen/water mixture results and the mixture is pumped to the surface where the bitumen is separated from the water. The bitumen is further upgraded and the produced water stream is then reused to produce more steam for extraction. As in the oil sand mining operations, the produced water stream may contain undesirable levels of heavy metals that need to be removed.

Thus, an effective process for removal of heavy metals including selenium, arsenic, barium, nickel and strontium from oil sands process or produced water is desirable, especially for the execution of aquatic and terrestrial reclamations projects.

The removal of selenium has been particularly challenging for the mining industry in general. In a recent review entitled “Review of Water Treatment for Selenium”, 15th Mining Industry Learning Seminar, University of Alberta, Edmonton, Jun. 17-18, 2013, Marek Mierzejewski & Tom Sandy, P. E., CH2M HILL, the authors pointed out the following challenges:
Significant variation in selenium levels and forms exists among the different industries, and in mining, among different minerals;
Given the complexities associated with industry-specific waters, no treatment technology is a “one-size fits all” solution;
Greater levels of post treatment are required as the starting selenium concentration increases;
Very few technologies have successfully removed selenium in water to less than 5 μg/L at any scale;
Even fewer technologies have been demonstrated at full-scale to remove selenium to less than 5 μg/L;
No full-scale selenium treatment system has operated for sufficient time to determine the long-term feasibility of the selenium removal technology;
No single technology has been demonstrated at full-scale to remove selenium to less than 5 μg/L for all industry sectors;
Tertiary treatment is required to meet both the selenium and other conventional pollutant criteria;
Residuals or by-product treatment will be required for most systems;
Membrane technologies can remove selenium to low levels assuming good scale control, with more challenges/costs in treatment due to pretreatment, tertiary treatment, brine recovery and reconstitution;
Very few guidelines have been established on reconstitution of RO permeate for discharge;
Thermal brine recovery can result in selenium bleed in the condensate;
Biological selenium reduction technologies are unproven for high salt (e.g. >1-2%); and
Ion exchange regenerant and membrane reject contain selenium in the soluble form.

Thus, there is a need among different industries, including the oil sand mining industry, for an effective method for removing heavy metals such as selenium, arsenic, barium, nickel and strontium, particularly selenium, from process/waste waters such as oil sands process water.

### SUMMARY OF THE INVENTION

This invention involves a passive process to remove heavy metals such as selenium present in wastewaters such as oil sands process water (OSPW). It was surprisingly discovered that petroleum coke produced during upgrading of bitumen, for example, during fluid coking or delayed coking, can be used to remove a substantial portion of heavy metals, including selenium. It was discovered that the deposition of a petroleum coke/OSPW slurry into a coke retention cell, where the water is allowed to contact the coke bed for a specified time (residence time), the heavy metals, including selenium, arsenic, barium, nickel and strontium, partition from the OSPW to the coke surface. This results in reduced heavy metals concentrations in the water treated in this fashion.

In one broad aspect of the invention, a process for treating water containing heavy metals is provided comprising:
removing petroleum coke from a coking operation;
forming a petroleum coke/water slurry by adding the water to be treated to the petroleum coke; and
depositing the petroleum coke/water slurry into a containment cell and retaining the petroleum coke/water slurry in the cell for a retention time sufficient to remove a portion of the heavy metals.

In one embodiment, the water containing heavy metals can be any industrial process water, for example, process water obtained from any stage of heavy oil extraction, for example, from SAGD operations, or oil sands mining operations. For example, but not meaning to be limiting, process water can be obtained from tailings reservoirs, end-pit lakes, upgrading facilities and the like. It is understood that the present invention can be used to treat any water source that has a substantial amount of heavy metals such as selenium, arsenic, barium, nickel and strontium. In one embodiment, the heavy metals are selected from the group consisting of selenium, arsenic, barium, nickel and strontium. In another embodiment, the heavy metal is selenium.

There are two main types of petroleum coke that can be produced depending on the type of coker reactor used, namely, a fluidized bed coker and a delayed coker. A typical fluid coke comprises particles having an average particle size of about 200 μm in diameter with an onion-like layered structure. Delayed coke, on the other hand, is produced in the form of larger lumps. Thus, when delayed coke is used in the present invention, the lumps of coke are preferably first pulverized to give a fine powder having an average particle size comparable to fluid coke.

In one embodiment, the petroleum coke is hot fresh fluid coke produced during fluid coking, where coke is produced at high enough rates such that the concentration of the coke in the resulting coke/water slurry can be expected to range from about 10% to about >40% by weight. It has been shown that optimum dosages will range between about 15% to about 30% by weight.

In one embodiment, the containment cell is constructed with under drains to permit a controlled rate of drainage that will ensure an appropriate residence time to maximize heavy metals, including selenium, removal. For example, the holding cell could be a dyke with perimeter embankments constructed using sand and the like.

In one embodiment, the retention time is about 2 weeks or longer. In another embodiment, the retention time is about 4 weeks or longer. In another embodiment, the retention time is at least 8 weeks. In another embodiment, the retention time ranges between 10 days and 12 weeks or longer.

### BRIEF DESCRIPTION OF THE DRAWINGS

The present invention, both as to its organization and manner of operation, may best be understood by reference to the following descriptions, and the accompanying drawings of various embodiments wherein like reference numerals are used throughout the several views, and in which:

FIG. 1 is a simplified schematic of a known fluid coking circuit for producing petroleum coke useful in the present invention.

FIG. 2 is a simplified schematic of a field pilot process line of the water treatment process of the present invention.

FIG. 3 is a bar graph showing selenium concentrations in oil sands process water before and after the water treatment process of the present invention.

FIG. 4 is a bar graph showing barium concentrations in oil sands process water before and after the water treatment process of the present invention.

FIG. 5 is a bar graph showing nickel concentrations in oil sands process water before and after the water treatment process of the present invention.

FIG. 6 is a bar graph showing strontium concentrations in oil sands process water before and after the water treatment process of the present invention.

FIG. 7 is a bar graph showing arsenic concentrations in oil sands process water before and after the water treatment process of the present invention.

FIG. 8 is a graph showing selenium removal as a function of residence time of OSPW/coke slurries in containment cells.

### DESCRIPTION OF THE PREFERRED EMBODIMENT

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In one aspect, the invention is concerned with a process for treating oil sand process water, for example, water recycled from oil sand tailings ponds. However, it is understood that the present invention can be used with any water that contains concentrations of heavy metals including selenium, arsenic, barium, nickel, strontium and the like.

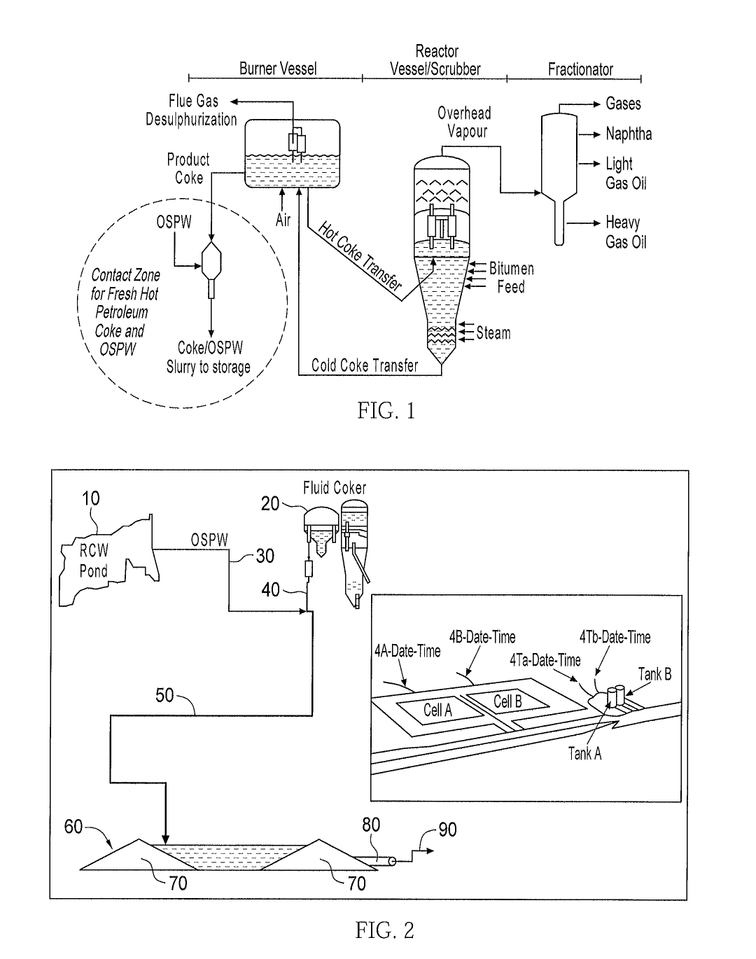

A fluid coking operation is illustrated in FIG. 1. It involves a fluidized bed coker reactor working in tandem with a fluidized bed coke burner. In the reactor, incoming feed oil contacts a fluidized bed of hot coke particles and heat is transferred from the coke particles to the oil. The reactor is conventionally operated at a temperature of between about 525° C. to 550° C. Hot coke entering the reactor is conventionally at a temperature of about 600-650° C. to supply the reactor heat requirement. “Cold” coke is continuously removed from the reactor and returned to the burner. The cold coke leaving the reactor is at a temperature of about 525° C. to 550° C. In the burner, the cold coke is partially combusted with air, to produce hot coke. Part of the hot coke is recycled to the reactor to provide the heat required. The balance of the hot coke is removed from the burner as product coke. The burner is conventionally operated at a temperature ranging between about 600-650° C. The burner temperature is controlled by the addition of air.

Ordinarily, when coke exits the coker burner, it is either recycled back to the coker reactor (referred to as “hot coke”) or disposed of as a by-product (referred to as “product coke” or “fresh product coke”). The fresh product coke can be temporarily stored in coke silos. However, in the present invention, the fresh product coke can be mixed with water such as oil sands process water (OSPW) to form an OSPW/coke slurry. For example, it can be mixed in a pipeline or in a mixing vessel or the like. The OSPW/coke slurry can be subsequently transferred (e.g., by means of a pipeline) to containment cells.

FIG. 2 is a schematic of a field pilot process line of the water treatment process of the present invention. In this embodiment, oil sand process water (OSPW) 30 is obtained from a recycle water pond 10, such as an oil sands tailings pond. Typically, process water present as the release water for recycle in the settling basins from open pit oil sands operations will contain heavy metals at concentrations exceeding the Canadian Council Ministers of the Environment (CCME) recommended values to support the protection of freshwater aquatic life, which may prevent the water from being released to the environment.

Petroleum coke 40 is removed from a burner vessel of a fluid coking operation and, in this embodiment, the OSPW 30 is mixed with petroleum coke 40 in line to produce the OSPW/coke slurry. Typically, the coke/water slurry is formed such that the coke concentration averages between about 15 to about 30% by wt. However, coke concentrations can range between about 10% by wt to about 40% by wt or higher. The coke/water slurry is then pumped through a pipeline 50 or the like using a slurry pump and deposited into containment cells 60.

In this embodiment, containment cell 60 is an earthen containment cell comprising a dyke 70, which can be a mined out pit or the like. Containment cell 60 further comprises an under-drain system 80 installed at the bottom to permit drainage. In one embodiment, the under-drain system may comprise a slotted HDPE pipe wrapped in a geotextile sock. This allows for the collection of the treated OSPW over time. In one embodiment, the containment cell 60 may be lined with a geotextile such as an impermeable low density polyethylene geotextile liner. In one embodiment, a pump can be equipped to the under-drain system.

The OSPW/coke is contained in the containment cell for a residence time sufficient to remove a substantial portion of the heavy metals. It was surprisingly discovered that initial mixing can elevate the levels of some heavy metals due to leaching from the petroleum coke itself. However, if the residence time is substantially increased, the concentrations of the heavy metals begin to decrease significantly. Residence time can be controlled by equipping the under-drain system with a valve or the like to control the drainage rates.

### Example 1

The field pilot process line as shown in FIG. 2 was tested for removal of heavy metals from OSPW. Two earthen containment cells (˜600 m³ each) and two steel tanks (˜60 m³ each) were used as containment cells (Cell A and B). Although the two earthen containments cells are more representative of a commercial scale design, geotechnical constraints on the land where the testing was done required the dyke height not to exceed 2 m in height. Thus, to mimic deeper containment cells and minimize potential water quality effects related to evaporation and precipitation, two standard size oil field tanks were included in these tests (Tank A and B).

The rate of release of the treated OSPW was controlled using an under drain system installed at the bottom of each deposit that permitted gravity drainage. The heavy metal concentration of the treated OSPW was determined as a function of time under natural climate conditions.

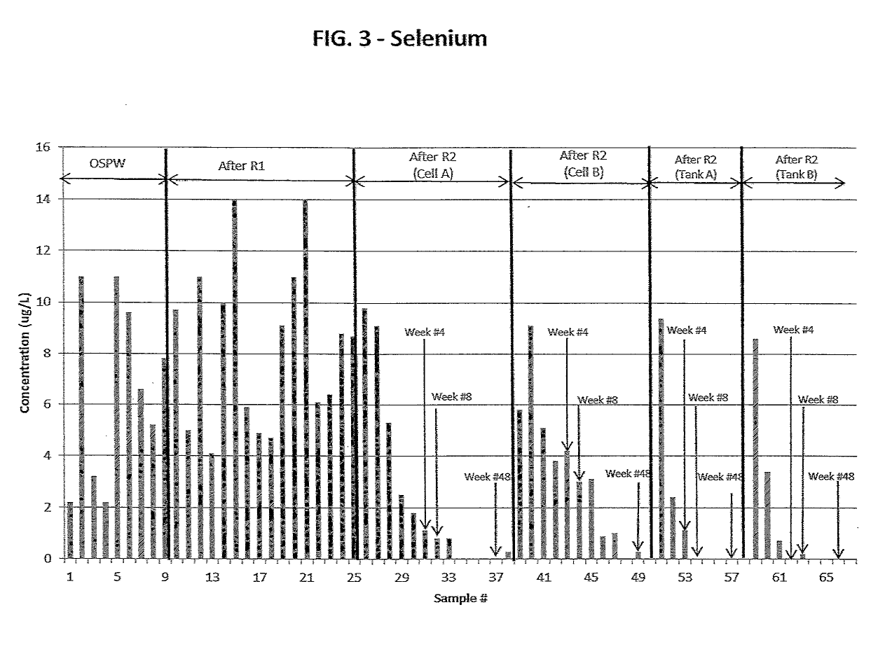

The OSPW was specifically tested for the presence of the heavy metals selenium, arsenic, barium, nickel and strontium. Tests were performed on pre-treated oil sand process water (referred to in FIGS. 3-7 as “OSPW”), the water contained in the OSPW/coke slurry after being transported in a pipeline but prior to being deposited in the various containment cells (referred to in FIGS. 3-7 as “After R1”), and at various retention times in the various containment cells (“After R2”), the containment cells referred to in FIGS. 3-7 as Cell A, Cell B, Tank A and Tank B, respectively. In the “After R2” panels, the marker arrows, designated week #4, week #8 and week #48, refer to residence times of 4, 8, and 48 weeks, respectively.

(a) Selenium

FIG. 3 is a bar graph showing the data collected during the field pilot study for selenium. The retention time of the OSPW/coke slurry in the various containment cells is indicated by the week markers. Samples 1-9 show selenium concentrations in the untreated process water ranged between about 2.2 and 11 μg/L and averaged about 6.5 μg/L. Samples 10-25 show selenium concentrations in the treated water after pipeline transport range between about 4.1 and 14 μg/L and averaged about 8.3 μg/L. The slight increase in selenium concentrations may be due to some leaching of selenium from the coke. However, steady and significant decreases were observed in the treated water after containment (After R2) in Cell A, Cell B, Tank A and Tank B. In particular, at week 4, the selenium concentration was already reduced from about 10 μg/L to about 1.0 μg/L. By week 48, the concentration of selenium was nearly undetectable. Thus, the treated water following retention contained selenium concentrations significantly reduced relative to the source OSPW.

(b) Barium

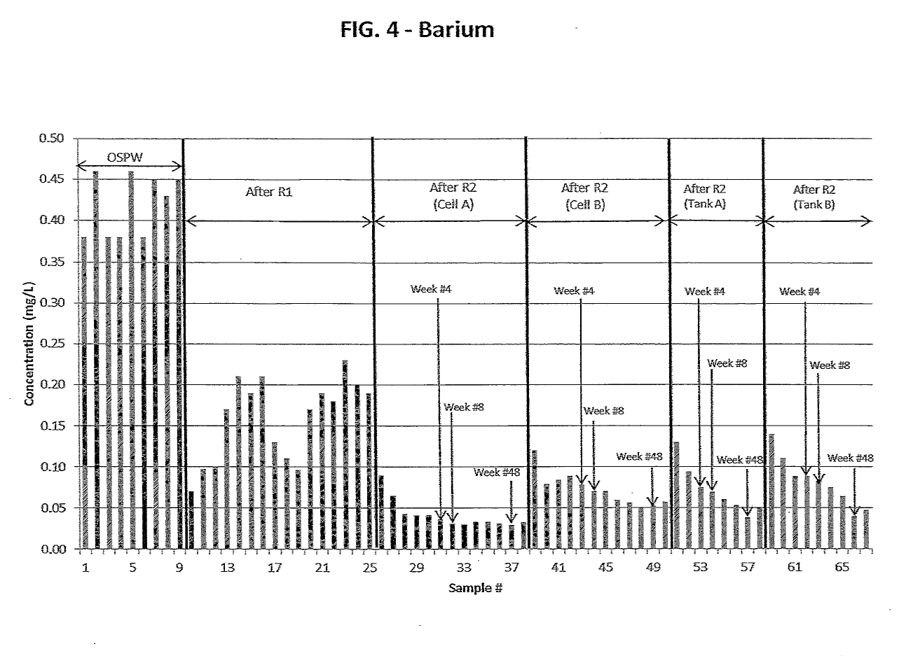

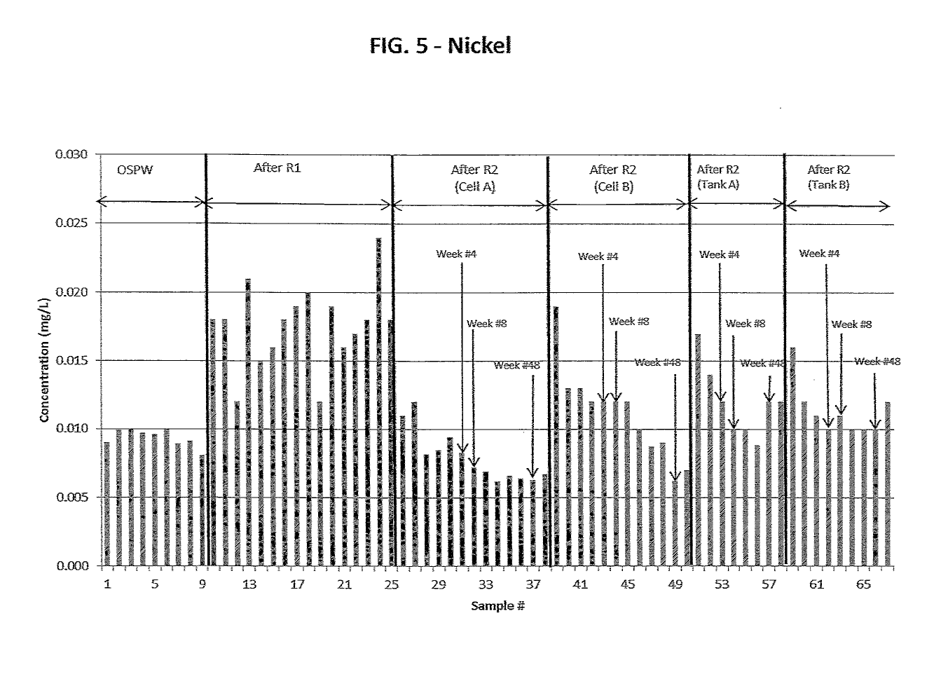

FIG. 4 is a bar graph showing the data collected during the field pilot study for barium. Samples 1-9 show barium concentrations in the untreated process water ranged between about 0.38 mg/L and 0.46 mg/L and averaged about 0.4 mg/L. Samples 10-25 (After R1) show barium concentrations in the treated water after pipeline transport ranged between about 0.09 and 0.22 μg/L and averaged about 0.15 mg/L. In this instance, there was a significant decrease in barium After R1. However, additional, significant decreases in barium were observed in the treated water after containment (After R2) in Cell A, Cell B, Tank A and Tank B. In Cell A, for example, it can be seen that barium concentrations dipped below 0.05 mg/L at week 4 and to about 0.35 mg/L at 8 weeks. After 48 weeks, the concentration of barium remained fairly constant. This trend was also observed in Cell B and Tanks A and B. Thus, the treated water following retention contained barium concentrations significantly reduced relative to the source OSPW.

(c) Nickel

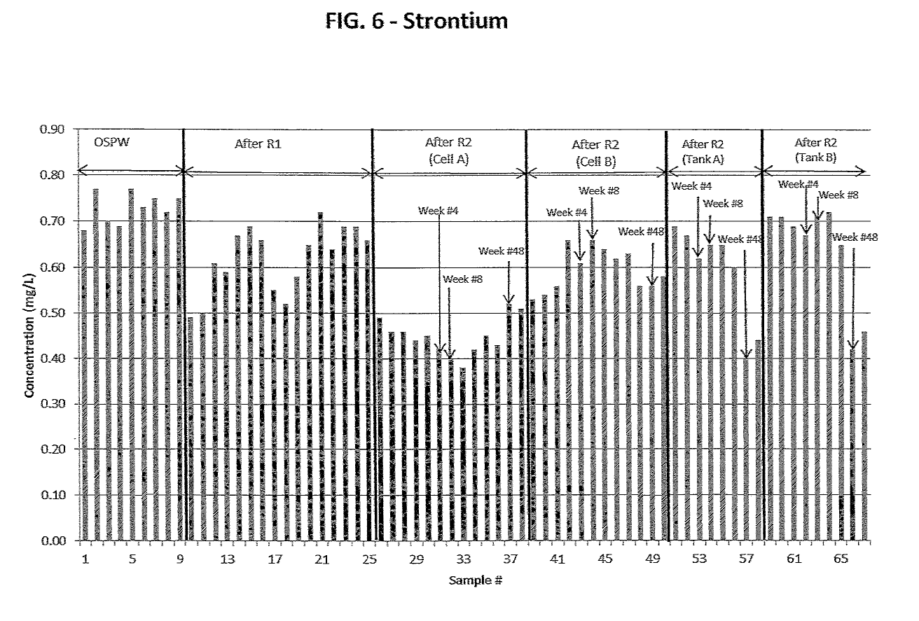

FIG. 5 is a bar graph showing the data collected during the field pilot study for nickel. Nickel concentrations in the source OSPW was about 0.010 mg/L. Following initial contact with petroleum coke (After R1), concentration increased to about 0.020 mg/L. The increase in nickel concentrations is likely due to some leaching of nickel from the coke. After four weeks retention in Cell A, concentrations decreased to about 0.008 mg/L and after 48 weeks to about 0.006 mg/L. Similar trends were also observed in Cell B and Tanks A and B.

(d) Strontium

FIG. 6 is a bar graph showing the data collected during the field pilot study for strontium. Strontium concentrations in the source OSPW ranged between about 0.5 and 0.8 mg/L. Following initial contact with petroleum coke (After R1), concentrations decreased. After about 8 weeks or so in Cell A, the strontium concentrations decreased to about 0.4 mg/L. In Tanks A and B, longer retention times were required to reach a strontium concentration of about 0.4 mg/L, i.e., about 48 weeks. However, overall, relative to the source water (identified as “OSPW” in FIG. 6), strontium was removed following sufficient contact and retention time with product coke.

(e) Arsenic

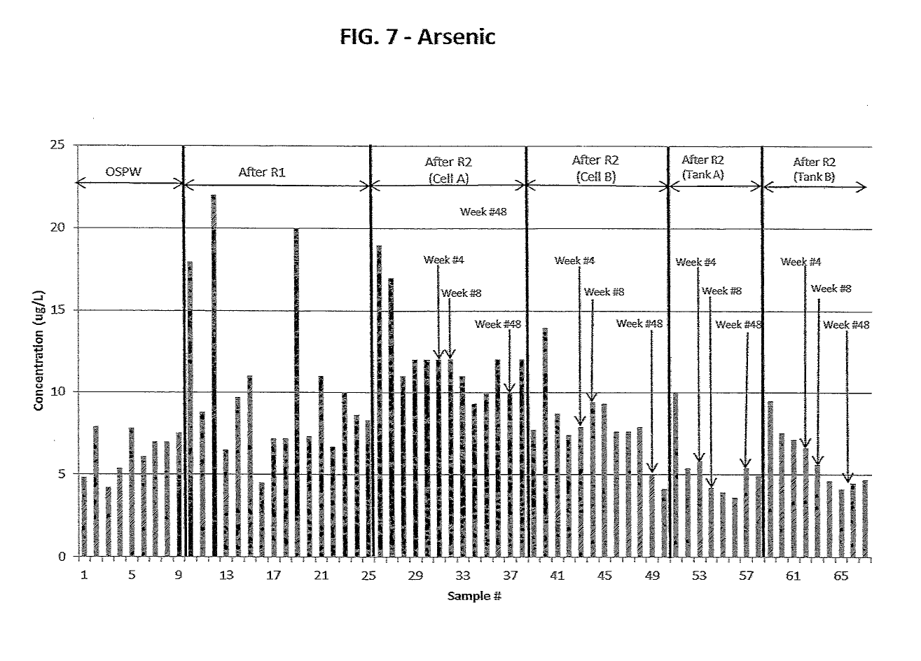

FIG. 7 is a bar graph showing the data collected during the field pilot study for arsenic. Concentrations of arsenic in the source OSPW ranged between about 5 and 10 μg/L. The OSPW After R1 showed a minor increase (˜2 μg/L) relative to the source water; however, there were subsequent concentration decreases after retention in Cell A, Cell B, Tank A and Tank B. Optimum retention time for arsenic removal was about 48 weeks.

### Example 2

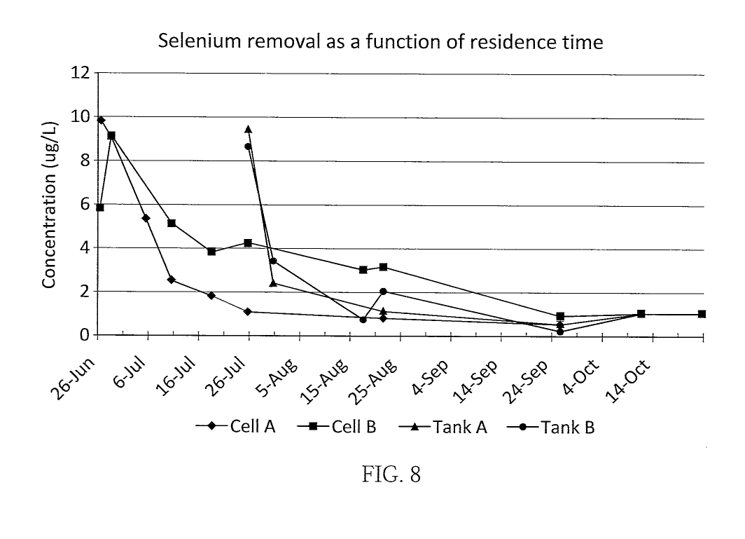

Selenium removal by petroleum coke was further studied as a function of retention time in Cell A, Cell B, Tank A and Tank B. FIG. 8 shows a steady decrease in selenium concentrations in all containment cells over the course of the study. After about 12 weeks, selenium concentrations appeared to have leveled out. The Canadian Council of Ministers of the Environment (CCME) has prescribed the following guidance values for selenium based on the intended water use:

Protection of Freshwater Aquatic Life—1 μg/L;

Protection of Agricultural (livestock)—50 μg/L.

As previously mentioned, oil sands process water typically contains selenium at concentrations between about 2 and 10 μg/L, which exceeds the freshwater aquatic life value recommended by CCME. Consequently, for water return and aquatic reclamation scenarios, reducing selenium concentrations in treated process water will help ensure regulatory acceptance.

### Example 3

Constant temperature experiments were completed using OSPW and were evaluated to assess changes in barium and strontium concentrations according to the amount of product coke added: 0%, 5%, 9-10%, 20%, 29-30%, and 38-40%. Evaluation was based on independent t-tests comparing the difference in average constituent concentrations between the 0 wt. % and 38-40 wt. % solutions. The results are shown in Table 1 below.

As coke dosages were increased, there was a statistically significant decrease in strontium (p=7.7×10−5) and barium (p=2.7×10−4) remaining in the OSPW. This provides additional evidence to support the observations shown in FIG. 4 (Arsenic) and FIG. 6 (Strontium).

TABLE 1

| | 0 | 5 | 9-10 | 20 | 29-30 | 38-40 |
|---|---|---|---|---|---|---|
| | (wt % | (wt % | (wt % | (wt % | (wt % | (wt % |
| | coke) | coke) | coke) | coke) | coke) | coke) |
| Ba | 0.20 | 0.23 | 0.12 | 0.08 | 0.07 | 0.05 |
| Avg. | | | | | | |
| (mg/L) | | | | | | |
| Sr | 0.62 | 0.63 | 0.56 | 0.51 | 0.47 | 0.41 |
| Avg. | | | | | | |
| (mg/L) | | | | | | |

The scope of the claims should not be limited by the preferred embodiments set forth in the examples, but should be given the broadest interpretation consistent with the description as a whole.

What is claimed:

1. A process for treating water containing heavy metals, comprising:
(a) removing petroleum coke from a coking operation;
(b) forming a petroleum coke/water slurry by adding the water to be treated to the petroleum coke; and
(c) depositing the petroleum coke/water slurry into a containment cell and retaining the petroleum coke/water slurry in the cell for a retention time sufficient to remove a portion of the heavy metals.

2. The process as claimed in claim 1, wherein the water containing heavy metals is industrial process water.

3. The process as claimed in claim 1, wherein the water containing heavy metals is process water obtained from any stage of heavy oil extraction.

4. The process as claimed in claim 1, wherein the water containing heavy metals is from an oil sands mining operation.

5. The process as claimed in claim 1, wherein the heavy metals are selected from the group consisting of selenium, arsenic, barium, nickel and strontium.

6. The process as claimed in claim 1, wherein the heavy metals comprises selenium.

7. The process as claimed in claim 1, wherein the retention time is about 2 weeks or longer.

8. The process as claimed in claim 1, wherein the retention time is about 4 weeks or longer.

9. The process as claimed in claim 1, wherein the retention time is at least 8 weeks.

10. The process as claimed in claim 1, wherein the retention time ranges between 10 days and 12 weeks or longer.

11. The process as claimed in claim 1, wherein the coking operation is a fluid bed coking operation and the petroleum coke is fluid coke.

12. The process as claimed in claim 1, wherein the coking operation is a delayed coking operation and the petroleum coke is delayed coke, the process further comprising:
(d) pulverizing the delayed coke to a powder having an average particle size of about 200 μm prior to forming the petroleum coke/water slurry.

13. The process as claimed in claim 1, wherein the petroleum coke in the petroleum coke/water slurry is between about 10 to about 50 percent by weight.

14. The process as claimed in claim 1, wherein the petroleum coke in the petroleum coke/water slurry is between about 15 to about 30 percent by weight.
